(19) United States
(12) Patent Application Publication
(10) Pub. No.: US 2024/0377136 A1
(43) Pub. Date: Nov. 14, 2024

(54) MELTING EQUIPMENT AND OPERATION METHOD FOR MELTING EQUIPMENT

(71) Applicant: DAIDO STEEL CO., LTD., Nagoya-shi (JP)

(72) Inventors: Satoshi HORI, Nagoya-shi (JP); Takashi YAMAUCHI, Nagoya-shi (JP); Masayuki SHIRATORI, Nagoya-shi (JP); Shoji KITABAYASHI, Nagoya-shi (JP); Kota MIZUTANI, Nagoya-shi (JP); Masashi KATO, Nagoya-shi (JP)

(21) Appl. No.: 18/643,250

(22) Filed: Apr. 23, 2024

(30) Foreign Application Priority Data
May 10, 2023 (JP) 2023-078187

(51) Int. Cl. F27D 11/10; F27B 3/08; F27D 19/00; H05B 7/144

(52) U.S. Cl. CPC F27D 11/10; F27B 3/085; H05B 7/144; F27D 2019/0028

(57) ABSTRACT

The present invention relates to a melting equipment including: two direct-current arc furnaces each including two or more graphite electrodes; a power supply unit including four or more power supply devices; a connection switching unit configured to selectively connect each of the power supply devices to each of the direct-current arc furnaces; and a power supply control unit configured to control power supply from each of the power supply devices to each of the direct-current arc furnaces, in which power supply to only any one of the two direct-current arc furnaces and simultaneous power supply to both direct-current arc furnaces are selectable, and during the simultaneous power supply, power is supplied exceeding 50% of capacities of all the power supply devices to any one of the direct-current arc furnaces.

### CROSS-REFERENCE TO RELATED APPLICATIONS

This application is based on and claims priority under 35 USC 119 from Japanese Patent Application No. 2023-078187 filed on May 10, 2023, the entire content of which is incorporated herein by reference.

### TECHNICAL FIELD

The present invention relates to a melting equipment and an operation method for the melting equipment, and particularly to a melting equipment that melts steel by using two direct-current arc furnaces and an operation method for the melting equipment.

### BACKGROUND ART

An arc furnace generates an arc between electrodes, and melts a metal material such as scrap by arc heat.

A basic configuration of melting equipment including a direct-current power supply, serving as a power supply that generates the arc, and a direct-current arc furnace is a combination of one power supply device for one direct-current arc furnace. However, in a process of melting steel, in addition to a melting period and a refining period that use power, there are other periods that basically do not use the power, such as a slag discharging period, a charging period, and a tapping period. Therefore, there is a problem that it is difficult to increase an operation rate of the power supply device to a certain level or more.

As melting equipment including a unit for increasing the operation rate of the power supply device, a twin-type direct-current arc furnace melting equipment has been known in which two power supply devices each having a capacity of 50% are configured to be capable of being connected selectively to two direct-current arc furnaces via a switching device (for example, Patent Literature 1 below).

However, since the melting equipment disclosed in Patent Literature 1 below has a configuration in which each furnace includes one electrode, it is difficult to cope with a large-sized furnace that requires power of, for example, 200 MW or more for melting. Further, since there are two power supply devices, when power is supplied simultaneously to both furnaces, the power that can be supplied to each furnace is limited to a capacity of 50% (half of a total capacity value of the power supply devices) at maximum, and it is difficult to distribute power efficiently.

Patent Literature 1: JP H6-331282A

### SUMMARY OF INVENTION

The present invention is based on the above circumstances, and an object thereof is to provide a melting equipment that can efficiently supply power to two large-sized direct-current arc furnaces, and an operation method for the melting equipment.

A melting equipment of a first aspect of the present invention is defined as follows. That is, the melting equipment includes:

two direct-current arc furnaces each including two or more graphite electrodes;

a power supply unit including four or more power supply devices;

a connection switching unit configured to selectively connect each of the power supply devices to each of the direct-current arc furnaces; and

a power supply control unit configured to control power supply from each of the power supply devices to each of the direct-current arc furnaces, in which

power supply to only any one of the two direct-current arc furnaces and simultaneous power supply to both direct-current arc furnaces are selectable, and during the simultaneous power supply, power is supplied exceeding 50% of capacities of all the power supply devices to any one of the direct-current arc furnaces.

According to the melting equipment of the first aspect defined as described above, each furnace has the configuration including two or more graphite electrodes, and it is also possible to cope with a furnace having a large furnace capacity (large-sized furnace) that requires large power.

Further, four or more power supply devices are shared by the two furnaces, and power of the power supply devices is interchanged when necessary, whereby an operation rate of the power supply device can be increased. Furthermore, in the melting equipment according to the first aspect, since power can be supplied by more than 50% of all the power supply devices to one furnace during simultaneous power supply, for example, even when a melting period that requires large power and a refining period in which small power is sufficient overlap in the two furnaces, it is possible to supply appropriate power according to each furnace period to each furnace.

Therefore, according to the melting equipment of the first aspect, it is possible to efficiently supply power to the two large-sized direct-current arc furnaces.

Here, the number of power supply devices provided in the power supply unit can be made larger than a total number of the graphite electrodes provided in the two direct-current arc furnaces (second aspect).

For example, in the case where each of the two direct-current arc furnaces has two graphite electrodes and the power supply unit has six power supply devices, power from the power supply devices can be distributed to each furnace at a ratio of 67% (capacities of the four power supply devices) and 33% (capacities of the two power supply devices) during the simultaneous power supply (third aspect).

In the melting equipment, in addition to the power supply device essential for supplying maximum input power per direct-current arc furnace, a backup power supply device can be connected to the direct-current arc furnace in a power-suppliable manner (fourth aspect).

In this way, even when any power supply device fails, a power supply device used for the power supply can be switched from the power supply device that fails to the backup power supply device in a short time to restart operation.

When power is supplied to the direct-current arc furnace from the backup power supply device in addition to the essential power supply device during power supply, the number of power supply devices in operation during the power supply is increased, and it is possible to operate each power supply device in a state of having a margin (in a state of reducing an output), and to reduce a failure rate of the power supply device and extend service life (fifth aspect).

The plurality of power supply devices can also be installed separately in two or more machine chambers.

In this way, the plurality of power supply devices can be disposed in different areas (machine chambers) for each group, and degree of freedom in an equipment layout can be increased (sixth aspect).

An operation method of the melting equipment of a seventh aspect to melt steel in the two direct-current arc furnaces, according to the present invention is defined as follows. That is, the method includes:

dividing a furnace period of the direct-current arc furnace into a melting period including a maximum power period in which maximum input power is supplied, a refining period in which power smaller than the maximum input power is supplied, a slag discharging period, a tapping period of tapping molten metal, and a charging period of charging a metal raw material;

when the maximum input power per furnace in the melting period is denoted as Sd, and a total capacity value of the power supply devices is denoted as Seqip, setting the maximum input power such that Seqip≥Sd is satisfied; and

supplying power to each of the direct-current arc furnaces so that the maximum power period of one direct-current arc furnace overlaps at least one of the slag discharging period, the tapping period, and the charging period of the other direct-current arc furnace, and that the melting period excluding the maximum power period and the refining period of the one direct-current arc furnace overlaps the melting period excluding the maximum power period and the refining period of the other direct-current arc furnace.

According to the operation method of the seventh aspect defined as described above, since the maximum power periods in which the maximum input power is supplied do not overlap in the two direct-current arc furnaces, an equipment cost can be reduced by saving (reducing) a capacity of the power supply device. Further, when the melting period excluding the maximum power period and the refining period of the direct-current arc furnaces are overlapped, an operation rate of the power supply device can be increased to perform efficient power supply.

### BRIEF DESCRIPTION OF DRAWINGS

FIG. 1 is a diagram showing a schematic configuration of melting equipment according to an embodiment of the present invention.

FIG. 2 is a diagram showing an example of transition of input power during operation in direct-current arc furnaces in FIG. 1.

FIG. 3 is a diagram showing connection destinations of power supply devices in an operation pattern in which melting periods of the two furnaces do not overlap each other.

FIG. 4 is a diagram showing a connection state between the direct-current arc furnaces and the power supply devices in a state A in FIG. 3.

FIG. 5 is a diagram showing a connection state between the direct-current arc furnace and the power supply devices in a state B in FIG. 3.

FIG. 6 is a diagram showing connection destinations of the power supply devices in an operation pattern in which melting periods of the two furnaces partially overlap.

FIG. 7 is a diagram showing main parts of melting equipment according to another embodiment of the present invention.

### DESCRIPTION OF EMBODIMENTS

Next, embodiments of the present invention will be described in detail with reference to the drawings.

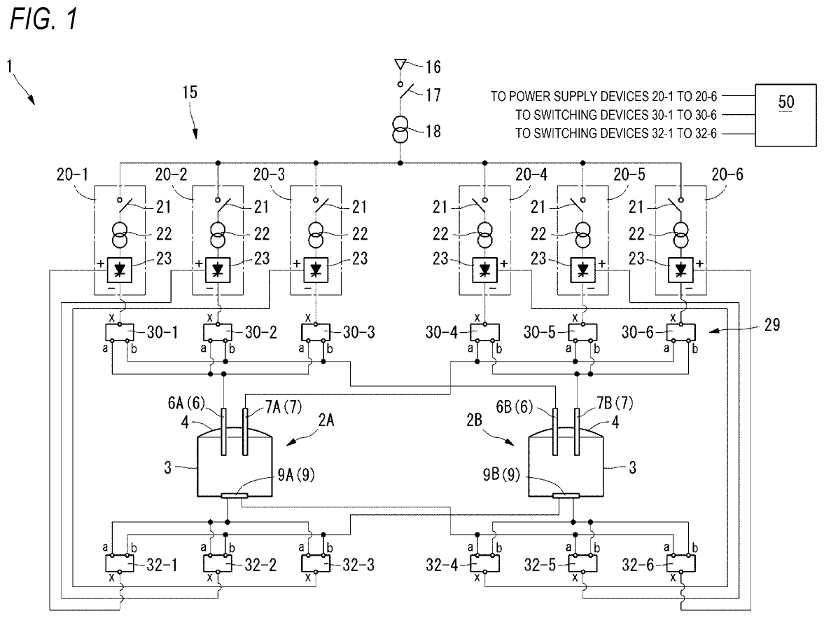

FIG. 1 is a diagram showing a schematic configuration of melting equipment according to an embodiment of the present invention. As shown in FIG. 1, melting equipment 1 according to the present embodiment is melting equipment in which two direct-current arc furnaces 2A and 2B are installed as one set, and further includes a power supply unit 15, a connection switching unit 29, and a power supply control unit 50.

The direct-current arc furnaces 2A and 2B each include a furnace body 3, a furnace lid 4 that covers an upper portion of the furnace body 3, two graphite electrodes 6 and 7 that protrude from near a central portion of the furnace lid 4 so as to rise and fall freely, and a furnace bottom electrode 9 provided at a substantially center of a bottom portion of the furnace body 3. An arc is generated between a metal material such as scrap charged into the furnace body 3 and tip ends of the graphite electrodes 6 and 7 to melt and heat the metal material. In the following description, the graphite electrodes of the direct-current arc furnace 2A are denoted as 6A and 7A, and the furnace bottom electrode of the direct-current arc furnace 2A is denoted as 9A, and the graphite electrodes of the direct-current arc furnace 2B are denoted as 6B and 7B, and the furnace bottom electrode of the direct-current arc furnace 2B is denoted as 9B.

In the direct-current arc furnaces 2A and 2B, molten steel (molten metal) in the furnace body 3 is tapped, through a melting period in which the metal material charged into the furnace body 3 is melted to generate the molten steel, a refining period in which heat rise and component adjustment of the generated molten steel are performed, and slag discharging in which at least a part of slag is discharged to outside of the furnace.

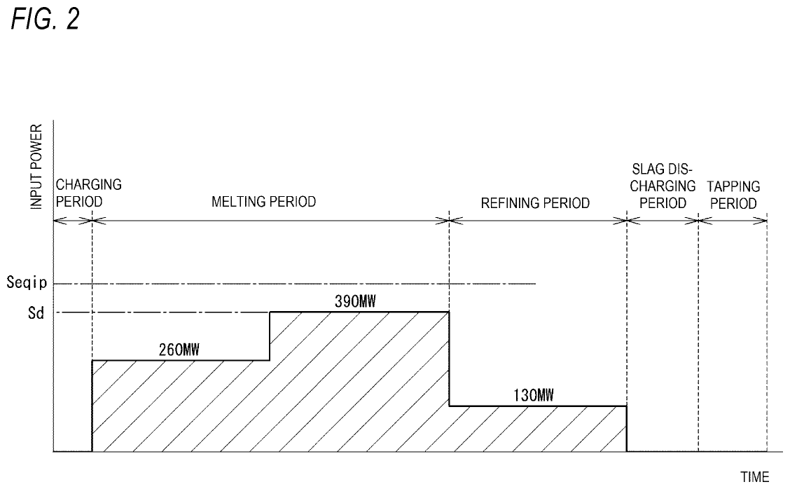

FIG. 2 is a diagram showing an example of transition of input power along an operation procedure from charging the metal material to tapping the molten steel in the direct-current arc furnace.

According to the example shown in FIG. 2, a period in which the input power is large is the melting period, and particularly a late period thereof is a maximum power period in which maximum input power Sd (390 MW) is supplied. Input power in the refining period carried out subsequent to end of the melting period is smaller than that in the melting period, and is 130 MW in the example. Power supply to the electrodes is basically not required for the slag discharging, the tapping, and the charging carried out following the refining period.

As shown in FIG. 1, the power supply unit 15 includes a power-receiving transformer 18 connected to a three-phase alternating-current power supply 16 via a main switch 17, and six power supply devices 20 (20-1 to 20-6) connected in parallel on a secondary side of the power-receiving transformer 18. The power supply unit 15 supplies direct-current power to the graphite electrodes 6 and 7 and the furnace bottom electrode 9 of the direct-current arc furnaces 2A and 2B.

Each power supply device 20 includes an auxiliary switch 21, a furnace transformer 22 that steps down alternating-current power to a predetermined voltage, and a thyristor 23 that converts the alternating-current power supplied from the furnace transformer 22 into the direct-current power. A cathode cable and an anode cable are connected to the thyristor 23. The direct-current power converted by the thyristor 23 is supplied to the graphite electrodes 6 and 7 of the arc furnace 2A or 2B via the cathode cable, and is supplied to the furnace bottom electrode 9 of the arc furnace 2A or 2B via the anode cable.

The maximum input power Sd described above needs to be covered by power supply from the power supply devices 20-1 to 20-6. The total capacity value Seqip of the six power supply devices needs to be equal to or larger than the maximum input power Sd (Seqip≥Sd). In the present example, when the capacity per power supply device is 70 MW, Seqip is 420 MW, which is larger than the maximum input power Sd (390 MW) described above.

The capacity Seqip of all the power supply devices may be the same as the maximum input power Sd. However, a failure rate of the power supply device 20 can be reduced by making Seqip slightly larger than Sd and operating the power supply device 20 with a margin for 100% capability of the power supply device 20. Therefore, Seqip≥Sd is preferable, and Seqip>Sd is more preferable.

On the other hand, an excessively large Seqip may result in an increased equipment cost. From a viewpoint of saving a power supply capacity, 2×Sd>Seqip is preferable.

The connection switching unit 29 includes 12 kinds of switching devices 30 (30-1 to 30-6) and 32 (32-1 to 32-6) disposed between the power supply devices 20 and the direct-current arc furnaces 2A and 2B. Each of the switching devices 30 and 32 includes one common contact x and two switching contacts a and b. The common contact x is connected to a direct-current output terminal of the thyristor 23 via a cable, the switching contacts a and b of the switching device 30 are connected to the graphite electrode 6 or 7 of the direct-current arc furnace 2A or 2B via a cable, and the switching contacts a and b of the switching device 32 are connected to the furnace bottom electrode 9 of the direct-current arc furnace 2A or 2B via a cable.

That is, each power supply device 20 can be selectively connected to any of the direct-current arc furnaces via the switching devices 30 and 32 that constitute the connection switching unit 29.

The power supply control unit 50 controls the power supply to the direct-current arc furnaces 2A and 2B based on a preset power supply pattern. The power supply devices 20-1 to 20-6 and the switching devices 30 (30-1 to 30-6) and 32 (32-1 to 32-6) described above are connected to the power supply control unit 50. For the power supply devices 20-1 to 20-6, the power supply control unit 50 controls power supply start and power supply stop and also controls outputs from the power supply devices during the power supply.

Further, for each of the switching devices 30 and 32, the power supply control unit 50 switches and controls conduction among the internal contacts x, a, and b so that each of the power supply devices 20 is connected to a scheduled arc furnace. At this time, a pair of switching devices connected to the common power supply device 20 (for example, the switching devices 30-1 and 32-1 both connected to the power supply device 20-1) are switched and controlled such that the arc furnace the same as each other is selected as a connection destination.

Next, a power supply operation during operation of the melting equipment 1 according to the present embodiment will be described.

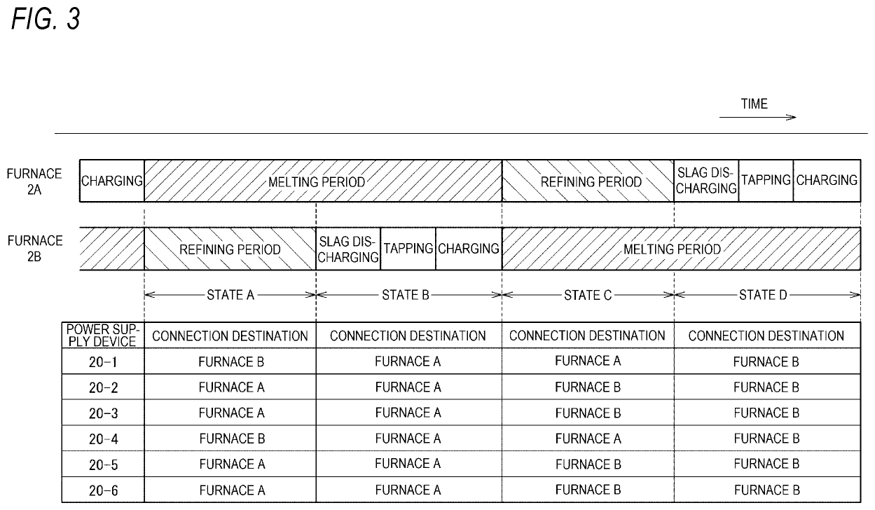

Here, first, as shown in FIG. 3, a case where respective melting periods of the direct-current arc furnaces 2A and 2B do not overlap each other will be described.

When the scrap is charged into the direct-current arc furnace 2A, in a state A shown in FIG. 3, connection destinations of the four power supply devices 20-2, 20-3, 20-5, and 20-6 corresponding to input power at the beginning of the melting period (260 MW) are switched to a direct-current arc furnace 2A side by the connection switching unit 29 to form a power supply circuit, and heating of the scrap in the furnace is started by an arc from the graphite electrodes 6A and 7A of the direct-current arc furnace 2A.

On the other hand, the direct-current arc furnace 2B is in the refining period in the state A, receives power supply from the remaining two power supply devices 20-1 and 20-4, and heats the molten steel with the input power of 130 MW.

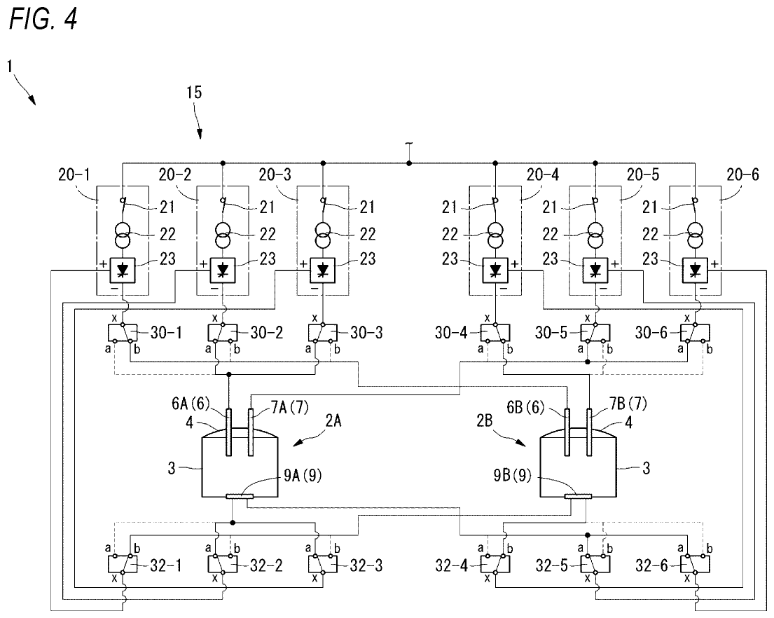

FIG. 4 is a diagram showing a connection state between the direct-current arc furnaces 2A and 2B and the power supply devices 20-1 to 20-6 in the state A.

Subsequently, in a state B shown in FIG. 3, when the direct-current arc furnace 2A is in a late period of the melting period, the power supply devices 20-1 and 20-4 are further switched to the direct-current arc furnace 2A side, and the direct-current arc furnace 2A receives power supply from all the six power supply devices, and promotes melting of the scrap with the maximum input power Sd (390 MW).

On the other hand, the direct-current arc furnace 2B is in a non-energized state in the state B, and the slag discharging, tapping, and charging new scrap are executed.

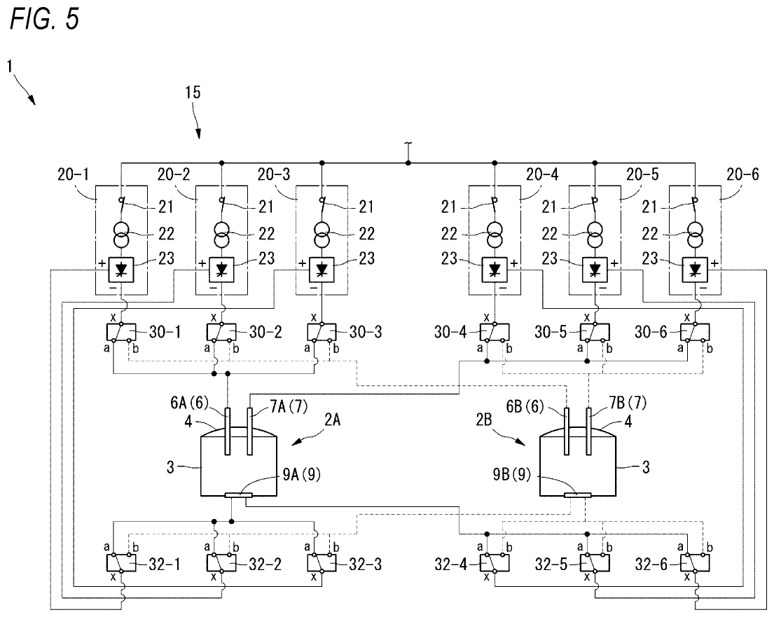

FIG. 5 is a diagram showing a connection state between the direct-current arc furnaces 2A and 2B and the power supply devices 20-1 to 20-6 in the state B.

Subsequently, in a state C shown in FIG. 3, the direct-current arc furnace 2A where the melting period ends receives the power supply from the power supply devices 20-1 and 20-4, and refining is subsequently performed.

On the other hand, the connection destinations of the remaining four power supply devices 20-2, 20-3, 20-5, and 20-6 are switched to a direct-current arc furnace 2B side to form a power supply circuit, and heating of the scrap charged into the furnace is started by an arc from the graphite electrodes 6B and 7B in the direct-current arc furnace 2B.

When the refining period of the direct-current arc furnace 2A ends, in a state D in FIG. 3, the molten steel is tapped following the slag discharging in the direct-current arc furnace 2A. Thereafter, new scrap is charged into the furnace.

On the other hand, the direct-current arc furnace 2B is in the late period of the melting period, the power supply devices 20-1 and 20-4 are further switched to the direct-current arc furnace 2B side, and the direct-current arc furnace 2B receives the power supply from all the six power supply devices and promotes melting of the scrap with the maximum input power Sd (390 MW).

According to the example in FIG. 3 as described above, since the maximum power periods in which the maximum input power Sd is supplied do not overlap in the two direct-current arc furnaces, an equipment cost can be reduced by saving (reducing) the capacity of the power supply device 20. Further, when the melting period excluding the maximum power period of one direct-current arc furnace and the refining period of the other direct-current arc furnace are overlapped, an operation rate of the power supply device 20 can be increased to perform efficient power supply.

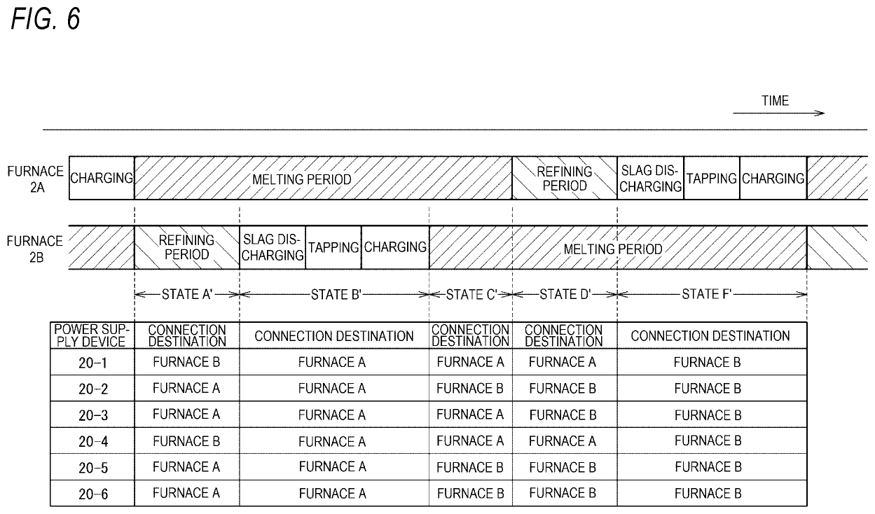

Next, as shown in FIG. 6, a case where the melting period of the direct-current arc furnace 2A and a part of the melting period of the direct-current arc furnace 2B overlap will be described.

A state A′ and a state B′ subsequent thereto shown in FIG. 6 are the same as the state A and the state B shown in FIG. 3.

In a subsequent state C′ shown in FIG. 6, while the melting period of the direct-current arc furnace 2A continues, the melting period also starts in the direct-current arc furnace 2B, and the melting period of the direct-current arc furnace 2A and a part of the melting period of the direct-current arc furnace 2B overlap. Therefore, in the state C′, the connection destinations of the power supply devices 20-2, 20-5, and 20-6 are switched to the direct-current arc furnace 2B side, the direct-current arc furnace 2A receives power supply from the three power supply devices and continues heating of the melting period, and the direct-current arc furnace 2B receives power supply from the three power supply devices and starts the heating of the melting period.

When the melting period of the direct-current arc furnace 2A ends, in a subsequent state D′ shown in FIG. 6, the direct-current arc furnace 2A receives the power supply from the power supply devices 20-1 and 20-4 and the subsequent refining is performed.

On the other hand, the connection destination of the power supply device 20-3 is switched to the direct-current arc furnace 2B side, and the direct-current arc furnace 2B receives the power supply from a total of four power supply devices 20 and melting of the scrap is promoted.

When the refining period of the direct-current arc furnace 2A ends, in a subsequent state F′ in FIG. 6, the molten steel is tapped following the slag discharging in the direct-current arc furnace 2A. Thereafter, new scrap is charged into the furnace.

On the other hand, the power supply devices 20-1 and 20-4 are further switched to the direct-current arc furnace 2B side, and the direct-current arc furnace 2B receives the power supply from all the six power supply devices, and further promotes the melting of the scrap with the maximum input power Sd (390 MW).

Also in the example in FIG. 6, since the maximum power periods in which the maximum input power Sd is supplied do not overlap in the two direct-current arc furnaces, the equipment cost can be reduced by saving (reducing) the capacity of the power supply device 20. Further, in the case where the melting period excluding the maximum power period and the refining period are overlapped, or the melting periods excluding the maximum power periods are overlapped between the two furnaces, the operation rate of the power supply device 20 can be increased to perform efficient power supply.

As described above, according to the melting equipment 1 of the present embodiment, each furnace has the configuration including the two graphite electrodes 6 and 7, and can also correspond to a furnace having a large furnace capacity (large-sized furnace) for which large power is required.

Further, the six power supply devices 20-1 to 20-6 are shared by the two furnaces 2A and 2B, and power of the power supply devices is interchanged when necessary, whereby non-energized time can be minimized, and the operation rate of the power supply device can be increased.

Furthermore, in the melting equipment 1 according to the present embodiment, during simultaneous power supply, power is supplied exceeding 50% of capacities of all the power supply devices to any one of the direct-current arc furnaces. For example, when a total capacity value of the six power supply devices is taken as a capacity of 100%, supplied power can be distributed to each furnace during simultaneous power supply at a ratio of 33:67 in addition to a ratio of 50:50. Therefore, for example, even when the melting period for which large power is required and the refining period in which small power is sufficient overlap in the two furnaces, it is possible to supply appropriate power according to each furnace period to each furnace.

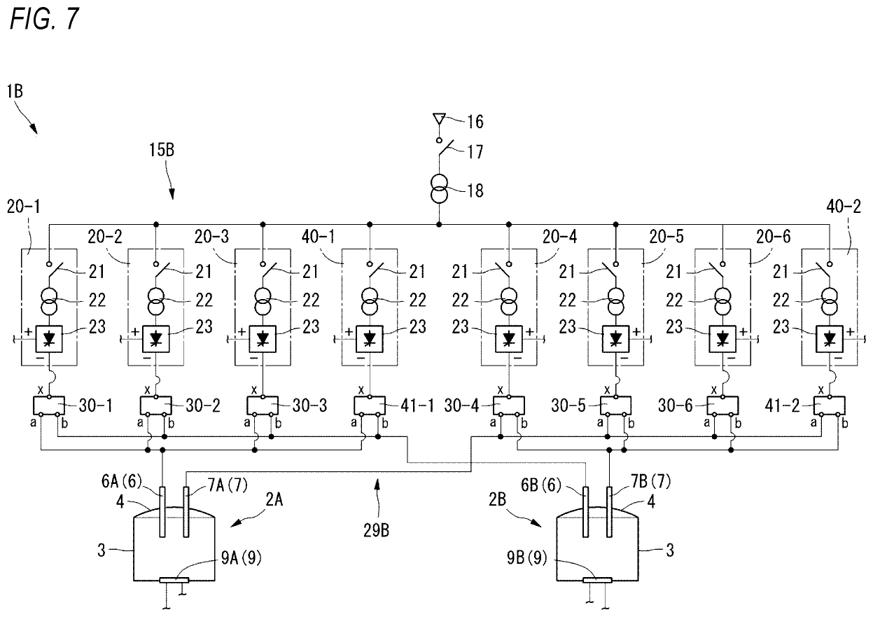

Next, FIG. 7 is a diagram showing main parts according to another embodiment of the present invention. In FIG. 7, description of cables that connect the power supply devices to the furnace bottom electrodes of the arc furnaces and switching devices 42 is omitted.

Melting equipment 1B in the present example includes the two direct-current arc furnaces 2A and 2B, a power supply unit 15B, and a connection switching unit 29B, and the basic configuration is the same as that of the melting equipment 1 described above. The configurations common to the melting equipment 1 described above among parts that constitute the melting equipment 1B are denoted by using the same reference numerals, and description thereof is omitted.

The power supply unit 15B in the present example includes two backup power supply devices 40 (40-1 and 40-2) in addition to the power supply devices 20-1 to 20-6 essential for supplying the maximum input power Sd per direct-current arc furnace. Here, the backup power supply device 40 is a power supply device not used for power input when a furnace period of one or the other arc furnace is the maximum power period. The capacity per power supply device 40 can be, for example, 70 MW similar to that of the power supply device 20.

Between the power supply devices 40 (40-1 and 40-2) and the direct-current arc furnaces 2A and 2B, switching devices 41 (41-1 and 41-2) and 42 (42-1 and 42-2, both not shown) that constitute the connection switching unit 29B are disposed. The switching devices 41 and 42 each include the one common contact x and the two switching contacts a and b. The common contact x is connected to a direct-current output terminal of the thyristor 23 via a cable, the switching contacts a and b of the switching device 41 are connected to the graphite electrode 6 or 7 of the direct-current arc furnace 2A or 2B via a cable, and the switching contacts a and b of the switching device 42 are connected to the furnace bottom electrode 9 of the direct-current arc furnace 2A or 2B via a cable.

That is, each power supply device 40 can be selectively connected to any of the direct-current arc furnaces via the switching devices 41 and 42 that constitute the connection switching unit 29B.

In the melting equipment 1B configured as described above, during operation (when a furnace period of at least one or the other arc furnace is in the maximum power period), the backup power supply devices 40 (40-1 and 40-2) are not used, and it is possible to perform predetermined power supply to the direct-current arc furnaces by only using the power supply devices 20-1 to 20-6, which is similar to the case of the melting equipment 1. On the other hand, when any of the power supply devices 20-1 to 20-6 fails, a power supply device used for the power supply can be switched from the power supply device that fails to a backup power supply device 40 (40-1 or 40-2) in a short time to restart operation.

In the melting equipment 1B, only when the furnace period of one or the other arc furnace is not in the maximum power period, it is also possible to perform the power supply to the direct-current arc furnaces from the backup power supply devices 40-1 and 40-2 in addition to the power supply devices 20-1 to 20-6. For example, when one direct-current arc furnace is in the melting period excluding the maximum power period, and the other direct-current arc furnace is in the refining period, power of 270 MW can be supplied to the one direct-current arc furnace by using the six power supply devices, and power of 130 MW can be supplied to the other direct-current arc furnace by using the two power supply devices.

In this way, the number of power supply devices in operation during the power supply is increased from six to eight, and it is possible to operate each power supply device in a state of having a margin (in a state of reducing an output per power supply device), and to extend service life of the power supply device.

The embodiments of the present invention have been described above in detail, but these are merely examples, and the present invention can be configured with various changes in a scope not departing from the gist thereof.

(1) For example, the number of graphite electrodes and power supply devices that constitute the melting equipment of the present invention is not limited to the embodiments described above, and can be appropriately changed. The embodiments described above are examples in which power is supplied to the two direct-current arc furnaces by using the six power supply devices, but the number of power supply devices that supply power in the embodiments described above can also be changed to five or seven or more. When the number of power supply devices is increased, it is possible to distribute the power supplied to the furnaces at a finer ratio during the simultaneous power supply.

(2) The structure of the furnace bottom electrode of the direct-current arc furnace is not particularly limited, and a type using a large number of relatively small-diameter steel bars (contact pins) (multi-pin method), a type using one to three relatively large-diameter steel bars (billets) (billet method), a type using conductivity of a brick itself without using the steel bar (contact body type), and the like can be appropriately adopted.

(3) A plurality of (six) power supply devices provided in the melting equipment according to the embodiments described above and shown in FIG. 1 can be divided into two groups, and installed in separate machine chambers. When the plurality of power supply devices are disposed in different areas (machine chambers) for each group, degree of freedom in an equipment layout can be increased.

(4) In the present invention, since the total capacity value Seqip of the power supply devices may be equal to or larger than the maximum input power Sd, it is possible to use all the capacities of the power supply devices. For example, in the example of the operation pattern shown in FIG. 3, it is possible to change the input power to the direct-current arc furnace 2A in the state A to 280 MW, the input power to the direct-current arc furnace 2A in the state B to 420 MW, and the input power to the direct-current arc furnace 2A in the state C to 140 MW.

### REFERENCE SIGNS LIST

1, 1B Melting equipment
2A, 2B Direct-current arc furnace
6, 6A, 6B, 7, 7A, 7B Graphite electrode
15, 15B Power supply unit
20, 20-1, 20-2, 20-3, 20-4, 20-5, 20-6 Power supply device
29, 29B Connection switching unit
30, 30-1, 30-2, 30-3, 30-4, 30-5, 30-6 Switching device
32, 32-1, 32-2, 32-3, 32-4, 32-5, 32-6 Switching device
40, 40-1, 40-2 Backup power supply device
41, 41-1, 41-2 Switching device
42, 42-1, 42-2 Switching device
50 Power supply control unit

What is claimed is:

1. A melting equipment comprising:
two direct-current arc furnaces each including two or more graphite electrodes;
a power supply unit including four or more power supply devices;
a connection switching unit configured to selectively connect each of the power supply devices to each of the direct-current arc furnaces; and
a power supply control unit configured to control power supply from each of the power supply devices to each of the direct-current arc furnaces, wherein
power supply to only any one of the two direct-current arc furnaces and simultaneous power supply to both direct-current arc furnaces are selectable, and during the simultaneous power supply, power is supplied exceeding 50% of capacities of all the power supply devices to any one of the direct-current arc furnaces.

2. The melting equipment according to claim 1, wherein
the number of the power supply devices provided in the power supply unit is larger than a total number of the graphite electrodes provided in the two direct-current arc furnaces.

3. The melting equipment according to claim 2, wherein
each of the two direct-current arc furnaces includes the two graphite electrodes, and the power supply unit includes the six or more power supply devices.

4. The melting equipment according to claim 1, further comprising a backup power supply device in addition to the power supply device essential for supplying maximum input power per direct-current arc furnace, wherein
the backup power supply device is connected to the direct-current arc furnace in a power-suppliable manner.

5. The melting equipment according to claim 4, wherein
during power supply, power is supplied to the direct-current arc furnace also from the backup power supply device in addition to the essential power supply device.

6. The melting equipment according to claim 1, wherein
the plurality of power supply devices are installed separately in two or more machine chambers.

7. An operation method of the melting equipment as described in claim 1 to melt steel in the two direct-current arc furnaces, the method comprising:
dividing a furnace period of the direct-current arc furnace into a melting period including a maximum power period in which maximum input power is supplied, a refining period in which power smaller than the maximum input power is supplied, a slag discharging period, a tapping period of tapping molten metal, and a charging period of charging a metal raw material;
when the maximum input power per furnace in the melting period is denoted as Sd, and a total capacity value of the power supply devices is denoted as Seqip, setting the maximum input power such that Seqip≥Sd is satisfied; and
supplying power to each of the direct-current arc furnaces so that the maximum power period of one direct-current arc furnace overlaps at least one of the slag discharging period, the tapping period, and the charging period of the other direct-current arc furnace, and that the melting period excluding the maximum power period and the refining period of the one direct-current arc furnace overlaps the melting period excluding the maximum power period and the refining period of the other direct-current arc furnace.
